(19) United States
(12) Patent Application Publication
(10) Pub. No.: US 2026/0307771 A1
(43) Pub. Date: Oct. 8, 2026

(54) ESTABLISHING SECURE COMMUNICATION BETWEEN AN INTERFACE DEVICE AND CONTROL SYSTEMS OF AN ELECTRIC MARINE VESSEL

(71) Applicant: VISION MARINE TECHNOLOGIES, BOISBRIAND (CA)

(72) Inventor: XAVIER MONTAGNE, LAVAL (CA)

(21) Appl. No.: 19/173,006

(22) Filed: Apr. 8, 2025

(51) Int. Cl. B63H 21/21; G06F 21/44

(52) U.S. Cl. CPC B63H 21/21; G06F 21/44; B63H 2021/216

(57) ABSTRACT

Various embodiments relate to a establishing secure communication between an interface device and control systems of an electric marine vessel. A gateway device receives an authentication request from an interface device via a first network interface. The gateway device, which is connected to a controller area network (CAN) bus through a CAN bus interface, authenticates the interface device using a token included in the authentication request. Upon successful authentication, the gateway device establishes a secure communication tunnel between the interface device and one or more vessel components connected to the CAN bus. The gateway device then proxies communication between the interface device and the vessel components through this secure tunnel, ensuring secure data exchange within the marine vessel's network infrastructure.

### FIELD OF THE TECHNOLOGY

The present disclosure relates to methods, apparatuses, and computer program products for establishing secure communication between an interface device and control systems of an electric marine vessel.

### BACKGROUND

Traditional marine vessels have predominantly relied on internal combustion engines (ICE) for propulsion, which typically involve complex mechanical systems and fuel-based power sources. These systems often require extensive maintenance and are subject to environmental regulations due to emissions. In recent years, there has been a shift towards integrating electric propulsion systems in marine vessels, driven by the need for cleaner and more efficient alternatives. Early electric marine vessels often utilized low-voltage battery systems and direct current (DC) motors, which limited their power output and range, making them suitable primarily for small boats or short-distance travel.

In the realm of electric marine vessels, communication between various onboard systems and external devices has traditionally been facilitated through standard communication protocols such as the Controller Area Network (CAN) bus. The CAN bus is a robust vehicle bus standard designed to allow microcontrollers and devices to communicate with each other without a host computer. However, the integration of external devices into this network may be limited by security concerns and the complexity of establishing secure communication channels.

### SUMMARY

According to embodiments of the present disclosure, various methods, apparatuses, and computer program products for establishing secure communication between an interface device and control systems of an electric marine vessel are described herein. In some aspects, a gateway device receives an authentication request from an interface device via a first network interface. The gateway device, which is connected to a controller area network (CAN) bus through a CAN bus interface, authenticates the interface device using a token included in the authentication request. Upon successful authentication, the gateway device establishes a secure communication tunnel between the interface device and one or more vessel components connected to the CAN bus. The gateway device then proxies communication between the interface device and the vessel components through this secure tunnel, ensuring secure data exchange within the marine vessel's network infrastructure.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth a block diagram of an example electric marine vessel in accordance with at least one embodiment of the present disclosure.

FIG. 1B sets forth a block diagram of an example marine propulsion system of an electric marine vessel in accordance with at least one embodiment of the present disclosure.

FIG. 1C sets forth a block diagram of an example high voltage battery of an electric marine vessel in accordance with at least one embodiment of the present disclosure.

FIG. 1D sets forth a block diagram of an example power distribution unit in accordance with at least one embodiment of the present disclosure.

FIG. 1E sets forth a block diagram of an example vessel control unit of an electric marine vessel in accordance with at least one embodiment of the present disclosure.

FIG. 2A sets forth a block diagram of an example security management module for authenticating powertrain components of an electric marine vessel in accordance with at least one embodiment of the present disclosure.

FIG. 2B sets forth another example of the security management module of FIG. 2A.

FIG. 3 sets forth a block diagram of an example system for establishing secure communication between an interface device and control systems of an electric marine vessel in accordance with at least one embodiment of the present disclosure.

FIG. 4 sets forth a block diagram of an example gateway device for establishing secure communication between an interface device and control systems of an electric marine vessel in accordance with at least one embodiment of the present disclosure.

FIG. 5 sets forth a flow chart of an example method of establishing secure communication between an interface device and control systems of an electric marine vessel in accordance with at least one embodiment of the present disclosure.

FIG. 6 sets forth a flow chart of an example method of establishing secure communication between an interface device and control systems of an electric marine vessel in accordance with at least one embodiment of the present disclosure.

FIG. 7 sets forth a flow chart of an example method of establishing secure communication between an interface device and control systems of an electric marine vessel in accordance with at least one embodiment of the present disclosure.

FIG. 8 sets forth a flow chart of an example method of establishing secure communication between an interface device and control systems of an electric marine vessel in accordance with at least one embodiment of the present disclosure.

FIG. 9 sets forth a flow chart of an example method of establishing secure communication between an interface device and control systems of an electric marine vessel in accordance with at least one embodiment of the present disclosure.

FIG. 10 sets forth a flow chart of an example method of establishing secure communication between an interface device and control systems of an electric marine vessel in accordance with at least one embodiment of the present disclosure.

### DETAILED DESCRIPTION

Advances in battery technology have paved the way for full-electric vehicles. Building on those advances, technology to enable full-electric watercraft has been widely adopted. However, the challenges of designing electric vehicles are different from the challenges of designing electric boats. The transformation of existing watercraft platforms to a full-electric platform also poses a different set of challenges. A particular challenge faced by electric watercraft is the weight and complexity of wire harnesses used to connect various powertrain components, and the scalability of the powertrain system.

The present invention relates to a communication architecture that provides isolation between CAN-connected control systems and the interface device(s) utilized by the vessel operator, while enabling securing communication between the two, thus limiting access to CAN-connected components via non-CAN network connections. In this way, an interface device such as the vessel dashboard or a user device cannot directly access the CAN bus. In some aspects, a gateway device receives an authentication request from an interface device via a first network interface. The gateway device, which is connected to a controller area network (CAN) bus through a CAN bus interface, authenticates the interface device using a token included in the authentication request. Upon successful authentication, the gateway device establishes a secure communication tunnel between the interface device and one or more vessel components connected to the CAN bus. The gateway device then proxies communication between the interface device and the vessel components through this secure tunnel, ensuring secure data exchange within the marine vessel's network infrastructure.

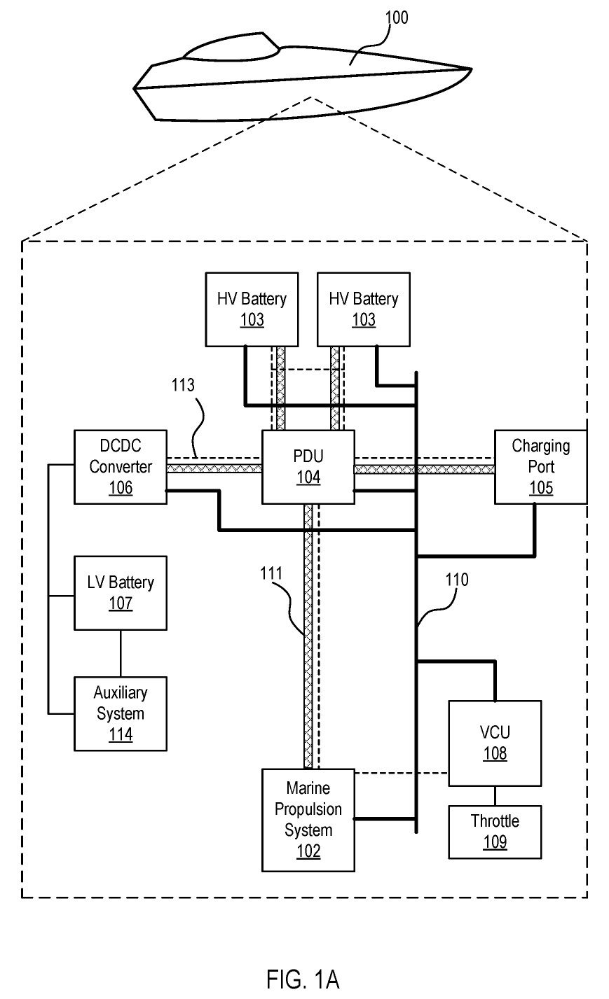

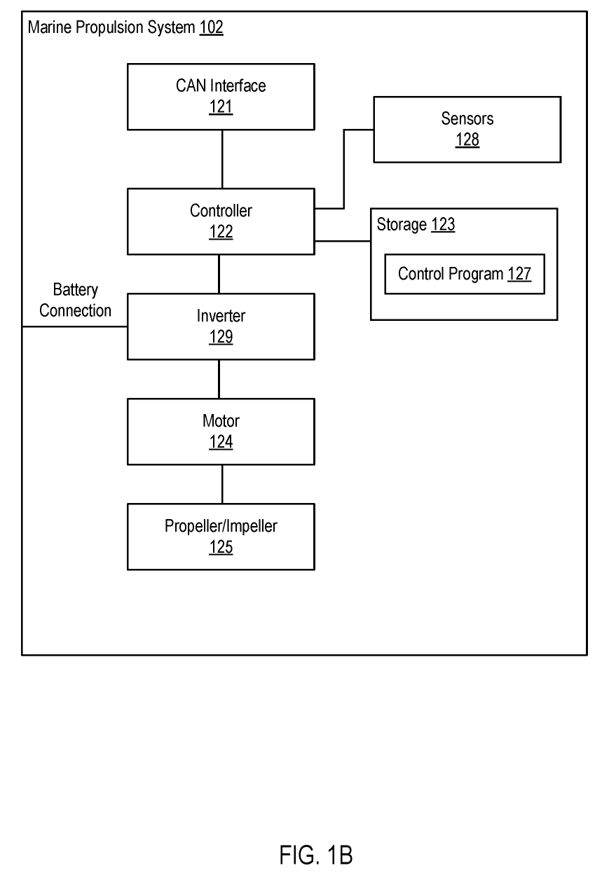

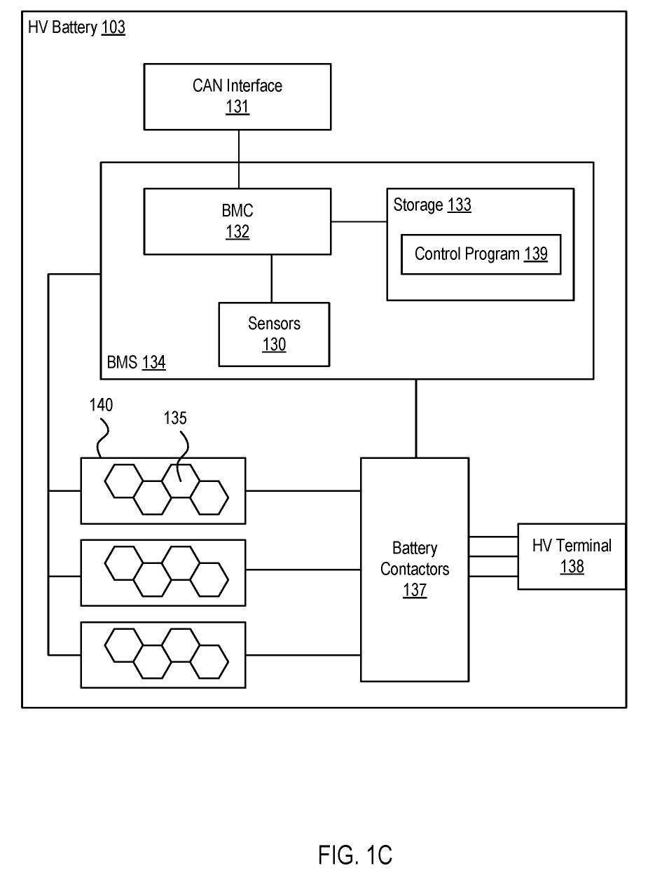

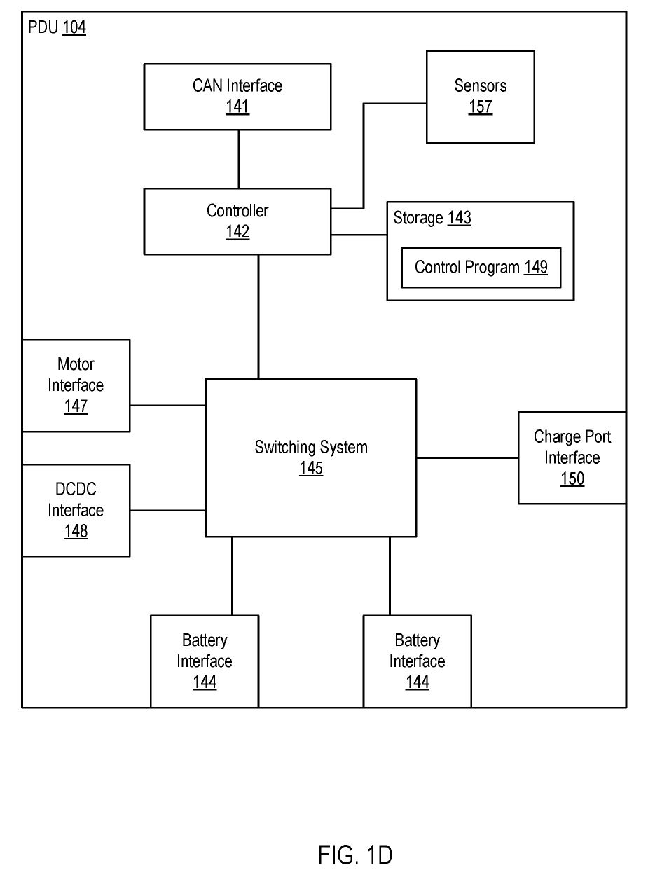

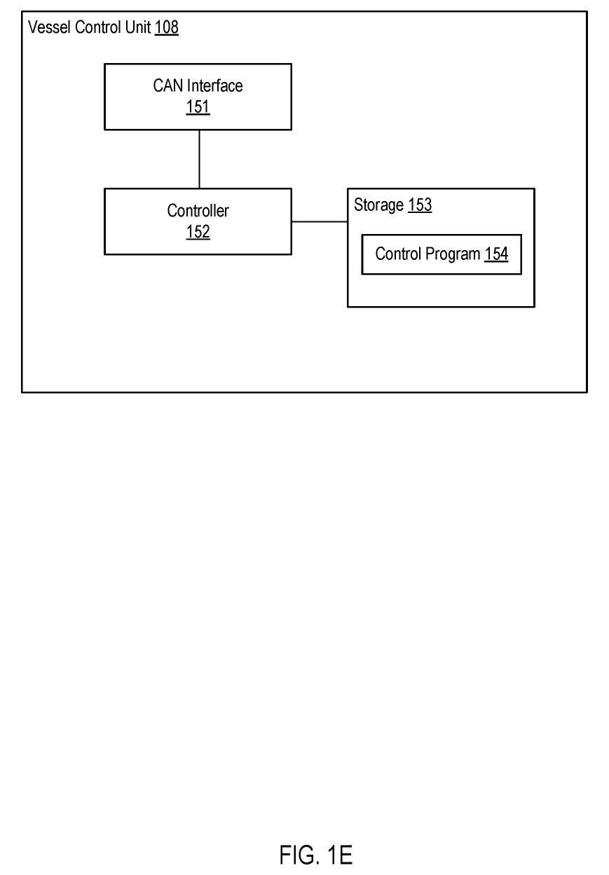

FIG. 1A sets forth an example electric vessel apparatus (hereinafter, “vessel”) 100 for authenticating powertrain components of an electric vessel by a battery management controller in accordance with the present disclosure. FIG. 1A is provided to emphasize the powertrain components of vessel 100. It will be appreciated that vessel 100 may include other components not shown or described herein. Vessel 100 may be any type of watercraft. In a particular example, vessel 100 includes a full-electric powertrain and thus may also referred to as an ‘electric boat.’ To that end, vessel 100 includes a marine propulsion system 102. The marine propulsion system is described in more detail below with reference to FIG. 1B. In a particular example, vessel 100 is a recreational electric boat and marine propulsion system 102 is a full-electric outboard motor powered by high voltage (e.g., 400V or more) batteries.

The marine propulsion system 102 is powered by one or more high voltage batteries 103. In the example, of FIG. 1A, two high voltage batteries 103 are shown; however, it will be appreciated a vessel 100 in accordance with the present disclosure may include fewer or more high voltage batteries. High voltage batteries operate at voltages ranging from a few hundred to over 800 volts, depending on the design and application. Higher voltages allow for more efficient power transmission and reduced current flow, which helps minimize energy losses. Each high voltage battery 103 includes multiple modules, each containing several individual battery cells connected in series and parallel configurations to achieve the desired voltage and capacity. These cells may be arranged in a pack that optimizes space utilization and facilitates thermal management. Each high voltage battery 103 includes or is coupled to a battery management system (BMS). The BMS is responsible for monitoring and controlling various parameters such as voltage, current, temperature, and state of charge (SoC) of individual cells within the pack. The BMS helps optimize battery performance, protect against overcharging or over-discharging, and ensures safety. The BMS communicates with other vessel components about battery state, receives commands to change the battery state, and controls the opening and closing of the main contactors in the battery. The high voltage battery 103 is described in more detail below with reference to FIG. 1C.

The marine propulsion system 102 receives power from the high voltage battery 103 via a power distribution unit (PDU) 104. The PDU 104 receives high-voltage DC power from the high voltage batteries 103 and routes it to different subsystems and components within vessel 100, such as the electric marine propulsion system 102 and other subsystems such as a DCDC converter 106. The PDU 104 also couples the high voltage batteries 103 to a charging port 105 for charging the high voltage batteries 103. The PDU 104, as explained in more detail below with reference to FIG. 1D, includes a set of contactors that are controlled by logic or software in the PDU 104 to ensure safety when switching the flow of power among various vessel components.

The DCDC converter 106 provides voltage conversion capabilities to step down the high-voltage DC power to lower voltages required by an auxiliary system 114, such as the 12-volt electrical system used for lights, accessories, and onboard electronics. The DCDC converter 106 may be used to charge a lower voltage battery such as a 12-volt marine battery 107.

Vessel 100 further includes a vessel control unit (VCU) 108. Vessel control unit 108 serves as the central control unit responsible for managing and coordinating various functions and systems onboard the vessel 100. For example, the vessel control unit 108 can provide propulsion control, including regulating engine speed, torque, and direction to achieve desired propulsion performance and maneuverability in accordance with commands or signals received from the vessel’s throttle control 109. The vessel control unit 108 can also manage the vessel’s steering system. The vessel control unit 108 can also control startup/shut down routines, control charging/operation mode selection, control the opening and closing of contactors in the PDU 104, monitor the state of onboard systems, perform vessel diagnostics, and interface with an operator dashboard. To that end, the vessel control unit 108 may communicate with the other vessel powertrain components (e.g., the marine propulsion system 102, the high voltage battery 103, the PDU 104, the DCDC converter 106, and so one) via a control area network (CAN), referred to herein as a CAN bus 110. The vessel control unit 108 will be described in more detail below with reference to FIG. 1E.

The CAN bus 110 may be a two-wire serial bus that allows multiple components and devices within a vessel to communicate with each other without a host computer. The CAN bus 110 may use a message-based communication scheme where components and devices send and receive data in the form of messages. Each message includes a CAN identifier (CAN ID), data bytes, and control bits. The CAN bus 110 may employ a multi-master architecture, in that any device on the network can initiate a message transmission. This distributed architecture allows for efficient communication between vessel components without the need for a centralized controller. In a particular example, the CAN bus 110 may implement the NMEA2000 protocol, a standard set forth by the National Marine Electronics Association. NMEA2000 provides optimization and messaging for a marine environment.

Vessel 100 can also include a high voltage interlock loop (HVIL) system, which is a safety feature designed to ensure the safe operation and maintenance of the high-voltage components. HVIL is a dedicated circuit that ensures the high voltage connectors are well inserted in the equipment mating connector to ensure the safety of the high voltage connections. HVIL is used by the high voltage battery BMS and the vessel control unit 108 to confirm the integrity of these connections before applying high voltage energy to each high voltage device in the vessel.

For ease of reference, in FIG. 1A power interconnects 111 supplying high voltage power are shown in hash-filled lines, data interconnects for CAN bus 110 are shown in thick solid black lines, and HVIL interconnects 113 are shown in dashed lines.

For further explanation, FIG. 1B sets forth a block diagram of an example of the electric marine propulsion system 102 in accordance with at least one embodiment of the present disclosure. The example marine propulsion system 102 of FIG. 1B includes a CAN interface 121 for coupling the marine propulsion system 102 to the CAN bus 110. For example, the CAN interface 121 may be a network interface controller configured to send and receive messages in the form of CAN frames over the CAN bus 110.

The example marine propulsion system 102 also includes a controller 122 coupled to the CAN interface 121. The controller 122 may include or implement a processor, a microcontroller, an Application Specific Integrated Circuit (ASIC), a programmable logic array (PLA) such as a field programmable gate array (FPGA), or other data processing unit in accordance with the present disclosure. In some examples, the controller is implemented by a processor or central processing unit configured to execute computer programming instructions, also referred to a computer executable instructions or processor executable instruction. Such instruction can be loaded from and stored in one or more memory devices collectively referred to as storage 123. Storage 123 may include electrically erasable programmable read-only memory (EEPROM) such as Flash memory (e.g., NAND and NOR flash memory or other types of solid-state memory), dynamic random-access memory (DRAM), static RAM (SRAM), magnetic disk storage, and the like. The storage 123 may be integrated with the controller 122 or provided as a separate memory device coupled to the controller 122.

The marine propulsion system 102 also includes an inverter 129 that that is powered by the high voltage batteries 103. The inverter 129 functions to convert the DC current received from the high voltage batteries 103 to alternating current (AC) that can be used by an electric motor. In some examples, the inverter 129 is a high voltage two-phase DC to a high voltage three-phase AC converter. The marine propulsion system also includes an electric motor 124 coupled to a propeller 125. The electric motor 124 is powered by the current received from the inverter 129. The electric motor 124 is an electric traction motor that turns a drive shaft (not shown) that drives the propeller 125. In some examples, the electric motor is a permanent magnet electric motor. The electric motor 124 is designed to withstand exposure to water and corrosive marine environments, featuring waterproof enclosures, sealed bearings, and corrosion-resistant materials to ensure reliable operation in wet conditions. The electric motor 124 operates quietly, producing minimal noise and vibration compared to traditional combustion engines, which contributes to a quieter boating experience as well as reduced noise pollution in aquatic environments. The electric motor 124 offers high efficiency and energy density, allowing electric boats to achieve comparable performance to traditional boats powered by combustion engines while using less energy and producing fewer emissions.

A control program 127 embodied in computer programing instructions is stored within tangible persistent storage of storage 123. When executed by the controller 122, the control program 127 is configured to receive commands from the vessel control unit 108 and control the electric motor 124 in accordance with those commands. For example, the control program 127 may be configured to regulate the distribution of electrical energy from the inverter 129 to the electric motor 124. In this example, the control program 127 may receive a throttle/speed command from the vessel control unit 108 and determine the frequency variation or voltage variation that will enter the electric motor 124 for controlling the vessel’s speed. The control program 127 is further configured to receive motor state information from various sensors 128 and supply motor state information and diagnostic information to the vessel control unit 108.

For further explanation, FIG. 1C sets forth a block diagram of an example of the high voltage battery 103 in accordance with at least one embodiment of the present disclosure. The example high voltage battery 103 of FIG. 1C includes a CAN interface 131 for coupling the high voltage battery 103 to the CAN bus 110. For example, the CAN interface 131 may be a network interface controller configured to send and receive messages in the form of CAN frames over the CAN bus 110. The example high voltage battery 103 includes array of battery cells 135 organized into battery modules 140 or battery packs, and a set of battery contactors 137 that selectively couple the battery modules 140 to high voltage terminals 138 of the battery 103.

The example high voltage battery 103 also includes a battery management system (BMS) 134 comprising a battery management controller 132 coupled to the CAN interface 131. Battery management controller 132 may include or implement a processor, a microcontroller, an ASIC, PLA such as an FPGA, or other data processing unit in accordance with the present disclosure. In some examples, battery management controller 132 is implemented by a processor or central processing unit configured to execute computer programming instructions, also referred to a computer executable instructions or processor executable instruction. Such instructions can be loaded from and stored in one or more memory devices collectively referred to as storage 133. Storage 133 may include EEPROM such as Flash memory (e.g., NAND and NOR flash memory or other types of solid-state memory), DRAM, SRAM, magnetic disk storage, and the like. The battery management system 134 further includes a variety of sensors 130 coupled to battery cells and other battery components for collecting battery state information. The storage 133 may be integrated with the battery management controller 132 or provided as a separate memory device coupled to the battery management controller 132.

The BMS 134 includes a control program 139 embodied in computer programing instructions stored in tangible persistent storage of storage 133. In some examples, the control program 139 controls the state of the battery contactors for selectively coupling and decoupling the battery modules 140 to the high voltage terminals 138 of the battery 103. In some examples, the control program 139 also monitors battery state information such as voltage, current, and temperature in battery cells 135 via the above-mentioned sensors. In some examples, the control program 139 also communicates with the vessel control unit 108 to provide battery state information. The control program also controls the charging of the battery cells 135.

For further explanation, FIG. 1D sets forth a block diagram of an example of the PDU 104 in accordance with at least one embodiment of the present disclosure. The example PDU 104 of FIG. 1D includes a CAN interface 141 for coupling the PDU 104 to the CAN bus 110. For example, the CAN interface 141 may be a network interface controller configured to send and receive messages in the form of CAN frames over the CAN bus 110. The PDU 104 also includes a battery interface 144 coupling the high voltage batteries 103 to a switching system 145 of the PDU 104, a charge port interface 150 coupling the charging port 105 to the switching system 145, a motor interface 147 coupling the marine propulsion system 102 to the switching system 145, and a DCDC interface 148 coupling the DCDC converter 106 to the switching system 145. The switching system 145 includes a set of contactors (not shown for simplicity) by which the PDU 104 supplies power from the high voltage batteries 103 to the marine propulsion system 102 and to the DCDC converter 106, or supplies power from the charging port 105 to the high voltage batteries 103.

The example PDU 104 also includes a controller 142 that may include or implement a processor, a microcontroller, an ASIC, PLA such as an FPGA, or other data processing unit in accordance with the present disclosure. In some examples, the controller 142 is implemented by a processor or central processing unit configured to execute computer programming instructions, also referred to a computer executable instructions or processor executable instruction. Such instructions can be loaded from and stored in one or more memory devices collectively referred to as storage 143. Storage 143 may include EEPROM such as Flash memory (e.g., NAND and NOR flash memory or other types of solid-state memory), DRAM, SRAM, magnetic disk storage, and the like. The storage 143 may be integrated with the controller 142 or provided as a separate memory device coupled to the controller 122.

The PDU 104 also includes a control program 149 embodied in computer programing instructions stored in tangible persistent storage of storage 143. When executed by the controller 142, the control program 149 is configured to receive commands from the vessel control unit 108 and control the switching system 145 to connect and disconnect power supplied to vessel components. The control program 149 is also configured to provide state information to vessel control unit 108. State information can be collected using one or more sensors 157.

For further explanation, FIG. 1E sets forth a block diagram of an example of vessel control unit 108 in accordance with at least one embodiment of the present disclosure. The example vessel control unit 108 of FIG. 1E includes a CAN interface 151 for coupling the vessel control unit 108 to the CAN bus 110. For example, the CAN interface 151 may be a network interface controller configured to send and receive messages in the form of CAN frames over the CAN bus 110.

The example vessel control unit 108 also includes a controller 152 that may include or implement a processor, a microcontroller, an ASIC, PLA such as an FPGA, or other data processing unit in accordance with the present disclosure. In some examples, controller 152 is implemented by a processor or central processing unit configured to execute computer programming instructions, also referred to a computer executable instructions or processor executable instruction. Such instructions can be loaded from and stored in one or more memory devices collectively referred to as storage 153. Storage 153 may include EEPROM such as Flash memory (e.g., NAND and NOR flash memory or other types of solid-state memory), DRAM, SRAM, magnetic disk storage, and the like. The storage 153 may be integrated with the controller 152 or provided as a separate memory device coupled to the controller 152.

The vessel control unit 108 also includes a control program 154 embodied in computer programing instructions stored in tangible persistent storage of storage 153. When executed by controller 152, the control program 154 is configured to send commands to other vessel components and receive state information and diagnostic data from vessel components as discussed above.

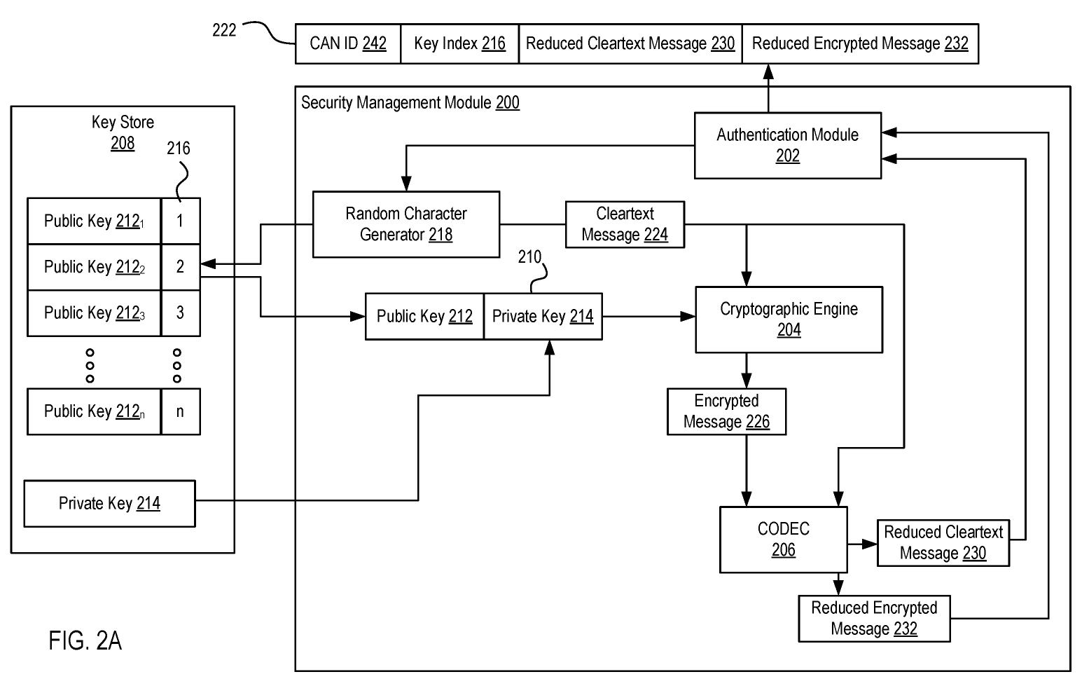

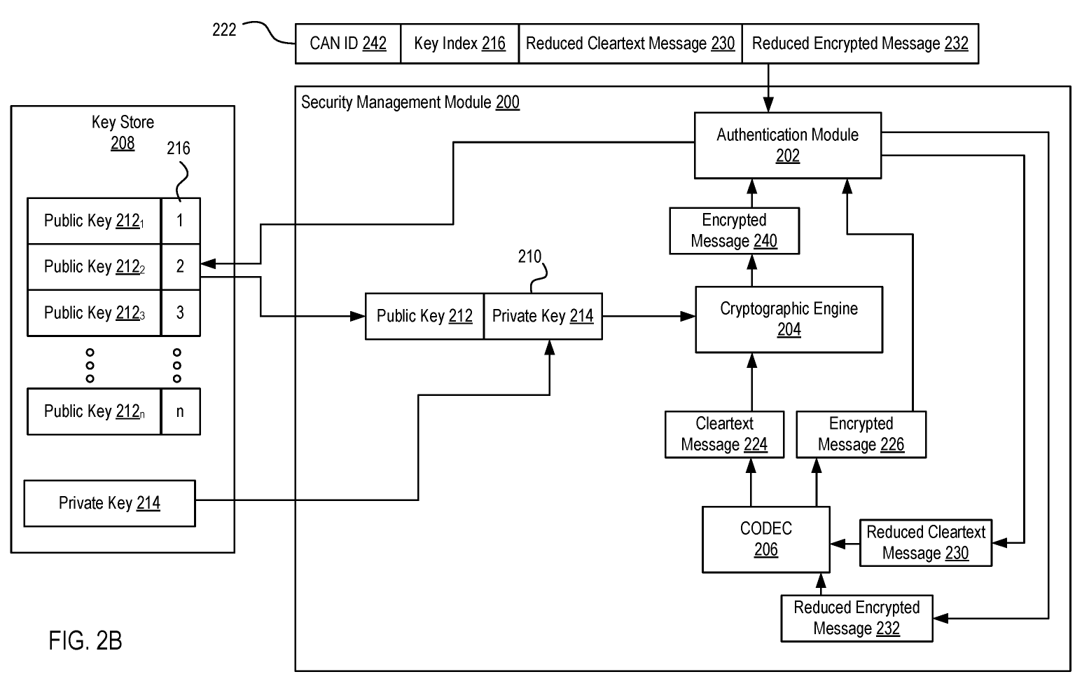

FIG. 2A sets forth an example security management module 200 for authenticating powertrain components of an electric vessel by a battery management controller in accordance with at least one embodiment of the present disclosure. In some examples, the security management module 200 is embodied in a set of computer programing instructions that are stored in a memory (e.g., the storage of FIGS. 1B-1E) that, when executed by a processor, cause the processor to implement the operations described below. In other examples, the security management module 200 may be implemented in digital logic, such as an application specific integrated circuit or programmable logic device.

The security management module 200 of a particular vessel component expects to receive an authentication message from one or more other vessel components. If an expected authentication message is not received, the security management module 200 signals a security error. For example, the list of vessel components for which the authentication message is expected may be stored in a memory device. The list may be a list of CAN identifiers corresponding to the vessel components for which the authentication message is expected. The security management module expects the authentication message at startup or system initialization. Thereafter, the security management module 200 may expect the authentication message based on an authentication schedule, which may be based on a timer. For example, if the security management module 200 does not receive the authentication message by the end of a timeout period since the last authentication message, the security management module 200 may signal a security error. The security management module 200 also authenticates each vessel component for which an authentication message is expected. The authentication of a vessel component is described in more detail below. If authentication of a vessel component fails, the security management module 200 may signal a security error. In response to detecting the security error, the vessel may be disabled. The mechanism for disabling the vessel may depend upon the vessel component that detects the security error, as described below.

In the example of FIG. 2A, the security management module 200 includes a cryptographic engine 204 configured to encrypt and decrypt data. For example, the cryptographic engine 204 can implement the AES128 encryption algorithm to encrypt and decrypt data. It will be appreciated by those of skill in the art that AES128is discussed as an illustrative example and that a cryptographic engine 204 in accordance with the present disclosure can be implemented using other encryption algorithms and key lengths. For encryption and decryption, the cryptographic engine 204 uses an encryption key 210 stored in a key store 208. The key store 208 is replicated on each genuine component of the vessel. In some examples, an encryption key 210 is produced by concatenating a public key 212 and a private key 214. For example, the public key 212 and the private key 214 are each 64-bit keys. In some implementations, the key store 208 includes multiple public keys 212₁₋ₙ that are each associated with a key index 216. To produce an encryption key 210, the cryptographic engine 204 selects one of the public keys 212₁₋ₙ based on the key index 216 (e.g., generated at random or provided in an authentication message, as discussed below), and concatenates the selected public key with the private key to produce a 128-bit encryption key. In some examples, the key store 208 is implemented by a data structure stored a memory device, such as any of the memory devices previously discussed. In some implementations, the private key 214 is stored separately in a secure storage device (not shown). In some examples, the private key 214 is encoded in all genuine components that are produced for the vessel. Thus, the private key 214 is pre-shared among the vessel components. The cryptographic engine 204 encrypts and decrypts messages using the encryption key 210. For example, a 128-bit encryption key is used to encrypt or decrypt a 128-bit message; however, these key lengths and message lengths are provided for illustrative purposes only. It will be appreciated that other key lengths, message lengths, and encryption algorithms may be employed. Additional explanations regarding encryption keys for encryption and decryption by the cryptographic engine 204 is provided below.

In the example of FIG. 2A, the security management module 200 also includes an encoder/decoder (‘codec’) 206 configured to encode and decode data in accordance with a particular scrambling protocol. For example, to scramble message data, codec 206 selects a subset of bytes of the message, where the byte positions in the data are preconfigured. In one example where 16 bytes of message data are input to the codec 206, the codec 206 selects byte 0, byte 7, byte 8, and byte 15 of the data to reduce the 16-byte message to a 4-byte message. To descramble data, codec 206 receives a subset of bytes of a message and reconstructs the message data from the subset of bytes using a descrambling mechanism. For example, knowing a priori the byte positions of the subset of bytes within the message to be decoded, the descrambling mechanism applies a particular order of XOR, SUM, and SHIFT operations to generate the missing bytes and reconstruct the original message data. In one example, codec 206 receives 4 bytes of message data. Knowing that the 4 bytes correspond to byte 0, byte 7, byte 8, and byte 15 and of the original message data, codec 206 applies the XOR, SUM, and SHIFT operations of the descrambling mechanism to generate the missing bytes of the 16-byte message data.

In the example of FIG. 2A, the security management module 200 also includes a random character generator 218. In some examples, the random character generator 218 generates a random number, or random text that is hashed to create a random number, which can be used as a key index 216 to select a public key 212. In some examples, the random character generator 218 can be used to generate cleartext for an authentication message, which is described in more detail below.

In the example of FIG. 2A, the security management module 200 also includes an authentication module 202 configured to generate authentication messages and authenticate vessel components based on received authentication messages. The operation of the security management module 200 to generate an authentication message 222 is now described. In response to a particular trigger (e.g., a timer or the receipt of an authentication message from another vessel component), the authentication module 202 initiates the generation of the authentication message 222 by requesting a random number from the random character generator 218. The authentication module 202 uses the random number as the key index 216 (e.g., ‘2’) to select a public key 212 (e.g., public key 212₂) from the key store 208. However, in alternative examples, a timer synchronized to the reception of the last CAN frame can be used to generate a random number. The public key 212 is concatenated with the private key 214 to produce the encryption key 210, which is supplied to the cryptographic engine 204.

The authentication module 202 also requests randomly generated text for a cleartext message 224 (e.g., 16 bytes of cleartext) from the random character generator 218. The cleartext message 224 is supplied to the cryptographic engine 204 and to codec 206. The cryptographic engine 204 encrypts the cleartext message 224 using the encryption key 210 to generate an encrypted message 226 (e.g., 16 bytes), which is provided to codec 206. Codec 206 encodes the cleartext message 224 and the encrypted message 226 by reducing the message based on selected byte positions, as discussed above. For example, codec 206 selects byte 0, byte 7, byte 8, and byte 15 of the cleartext message 224 to generate a reduced cleartext message 230 (4 bytes) and selects byte 0, byte 7, byte 8, and byte 15 of the encrypted message 226 to generate a reduced encrypted text message 232 (4 bytes). It will be appreciated that the number of bytes and byte positions used to reduce a message are provided for illustrative purposes only.

The authentication module 202 generates the authentication message 222 by constructing a CAN frame that includes the key index 216, the reduced cleartext message 230, and the reduced encrypted message 232. The authentication message 222 is then transmitted over the CAN bus. In some examples, the authentication message 222 also includes an identifier, such as a CAN identifier, of the vessel component transmitting the authentication message 222.

For further explanation, FIG. 2B illustrates the operation of the security management module 200 to authenticate another vessel component based on an authentication message 222 received from that vessel component. In some examples, the authentication message includes the CAN identifier 242 of the vessel component, a key index 216, the reduced cleartext message 230, and the reduced encrypted message 232. The reduced cleartext message 230 is provided to the codec 206, which reconstructs the cleartext message 224 from the reduced cleartext message 230 based on the known mapping between the bytes of the reduced cleartext message 230 and their byte positions within the cleartext message 224, and further by application of the descrambling mechanism to supply the missing bytes. Likewise, the reduced encrypted message 232 is provided to the codec 206, which reconstructs the encrypted message 226 from the reduced encrypted message 232 based on the known mapping between the bytes of the reduced encrypted message 232 and their byte positions within the encrypted message 226, and further by application of the descrambling mechanism to supply the missing bytes.

The key index 216 provided in the authentication message 222 is used to identify a public key 212 from the key store 208. The authentication module 202 concatenates the corresponding public key 212 with the private key 214 to produce the encryption key 210, which is supplied to the cryptographic engine 204. The cleartext message 224 is also supplied to the cryptographic engine 204, which encrypts the cleartext message 224 to generate another encrypted message 240. The authentication module 202 then compares the received encrypted message 226 to the generated encrypted message 240 to determine whether they are identical. If the encrypted message 226 and the encrypted message 240 are identical, the vessel component associated with the CAN identifier 242 in the authentication message 222 is authenticated, in that the security management module 200 determines that the vessel component is a genuine component. If the encrypted message 226 and the encrypted message 240 are not identical, the security management module 200 may signal to a vessel component controller that one or more vessel components have failed authentication, which allows the vessel component controller to perform an error handling action.

Although the authentication protocol described above includes comparing the received encrypted message 226 to the encrypted message 240 generated by encrypting the cleartext message 224, in alternative implementations the authentication module 202 can decrypt the encrypted message 226 to generate cleartext, and compare that cleartext to the cleartext message 224.

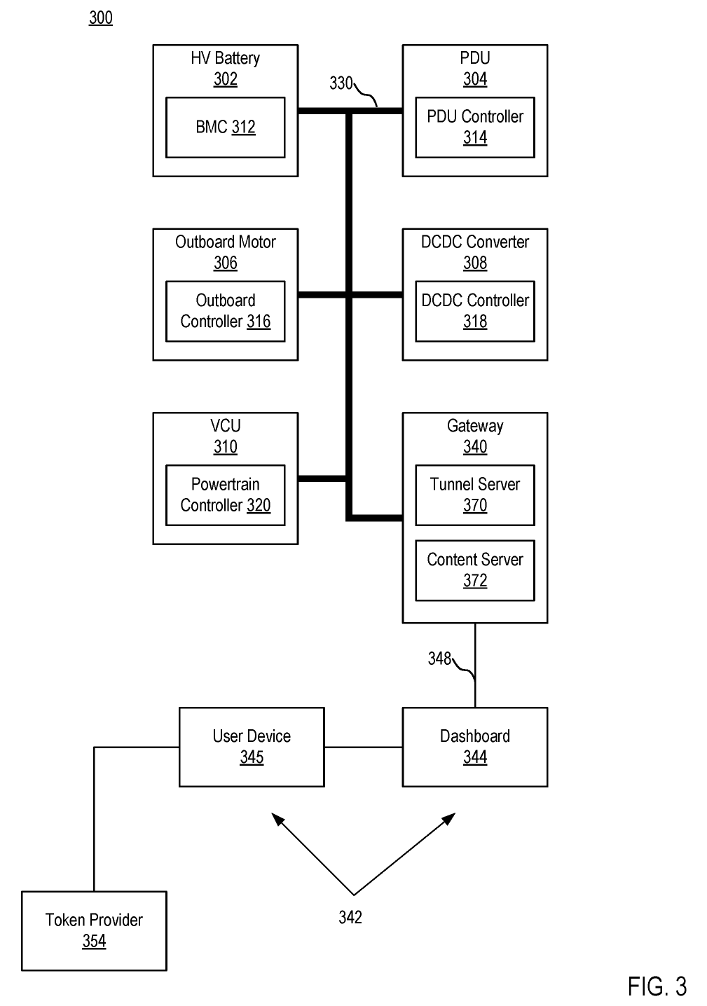

For further explanation, FIG. 3 sets forth an example communication system 300 for establishing secure communication between an interface device and control systems of an electric marine vessel (e.g., vessel 100 in FIG. 1A) in accordance with at least one embodiment of the present disclosure. The example system 300 includes VCU 310, one or more HV batteries 302, PDU 304, outboard motor 306, and DCDC converter 308, which are communicatively coupled via a CAN bus 330. In some examples, CAN bus 330 implements CAN bus 110 of FIG. 1A. All commands and data communication between powertrain components are sent over CAN bus 330 and are implemented through CAN frames, eliminating traditional control wiring. The CAN bus can be implemented using industry-standard protocols such as CAN 2.0 or CAN FD (Flexible Data-rate). In some examples, the physical layer can conform to ISO 11898-2 or ISO 11898-3 standards for high-speed or fault-tolerant operation, respectively. In some implementations, CAN bus 330 includes a data bus for sending commands, responses to commands, and data (e.g., parameters and state information), as well as a diagnostic bus for accessing, sending, and receiving diagnostic information. Each component on the CAN bus has a unique identifier, allowing precise addressing and prioritization of messages.

In the example communication system 300 of FIG. 3, HV battery 302 includes a BMC 312. Only one HV battery 302 is shown in FIG. 3 for simplicity, although it will be appreciated that system 300 may include more than one battery that is connected to system components in the manner that HV battery 302 is connected. In some examples, the HV battery 302 and BMC 312 implement the battery 103 and BMC 132 shown in FIGS. 1A and 1C. In various examples, BMC 312 is implemented by a microcontroller, a processor coupled to a memory, or other digital logic device that will be appreciated by those of skill in the art. BMC 312 implements battery control operations such as opening and closing power contactors, battery state monitoring, and so on. BMC 312 also reports state information over CAN bus 330.

In the example communication system 300 of FIG. 3, PDU 304 includes a PDU controller 314 coupled to CAN bus 330. In some examples, the PDU 304 and PDU controller 314 implement the PDU 104 and PDU controller 142 shown in FIG. 1A and 1D. In various examples, PDU controller 314 is implemented by a microcontroller, a processor coupled to a memory, or other digital logic device that will be appreciated by those of skill in the art. PDU controller 314 implements PDU control operations such as selectively opening and closing power contactors coupled to the HV battery 302 and motor in accordance with VCU commands and detected faults. PDU controller 314 also reports state information over CAN bus 330.

In the example communication system 300 of FIG. 3, electric outboard motor 306 includes an outboard controller 316. In some examples, outboard motor 306 and outboard controller 316 implement marine propulsion system 102 and controller 122 of FIGS. 1A and 1B. In various examples, outboard controller 316 is implemented by a microcontroller, a processor coupled to a memory, or other digital logic device that will be appreciated by those of skill in the art. Outboard controller 316 implements outboard control operations such as opening and closing power contactors, motor state monitoring, motor speed, propeller direction, and so on. Outboard controller 316 also reports state information over CAN bus 330.

In the example communication system 300 of FIG. 3, DCDC converter 308 includes a DCDC controller 318. In some examples, DCDC converter 308 implements DCDC converter 106 in FIG. 1A. In various examples, DCDC controller 318 is implemented by a microcontroller, a processor coupled to a memory, or other digital logic device that will be appreciated by those of skill in the art. DCDC controller 318 implements DCDC converter operations such as charge cycling of a low voltage battery as well as supplying power to auxiliary systems. DCDC controller 318 also reports state information over CAN bus 330.

In the example communication system 300 of FIG. 3, VCU 310 includes a powertrain controller 320. In some examples, VCU 310 and powertrain controller 320 implement VCU 108 and controller 152 in FIGS. 1A and 1E. In various examples, powertrain controller 320 is implemented by a microcontroller, a processor coupled to a memory, or other digital logic device that will be appreciated by those of skill in the art. Powertrain controller 320 implements powertrain control commands and state monitoring of powertrain components such as HV battery 302, PDU 304, and outboard motor 306. Each powertrain component’s controller processes the received CAN commands and independently executes the required action without further control by VCU 310 or any other device. For example, the motor controller adjusts speed based on the VCU’s commands, while the PDU controller controls contactor opening and closing to enable safe operation.

The example communication system 300 of FIG. 3 also includes a gateway 340 coupled to CAN bus 330 and configured for communication over CAN bus 330 with the VCU 310 and other CAN-connected components (e.g., HV batteries 302, PDU 304, outboard motor 306, and DCDC converter 308) using the communication protocols described above. Gateway 340 is coupled to CAN bus 330 through a CAN interface like VCU 310 and other CAN-connected components. Unlike VCU 310 and other CAN-connected components, gateway 340 also includes a network interface for communication over a local network 348. The network interface can include interfaces for wireless and wired network communication, including Ethernet, Universal Serial Bus (USB), Bluetooth, Wi-Fi, and the like. For example, local network 348 may be implemented by an Ethernet cable, a Wi-Fi network, and combinations thereof. For example, the local network may be an internet protocol (IP) or other packet network that is isolated from the CAN bus 330. Local network 348 may couple one or more vessel interface devices 342 to gateway 340. As such, gateway 340 is an intermediary between this local network 348 and the CAN bus 330.

In some examples, vessel interface device 342 is a dashboard 344. For example, dashboard 344 may provide an interface for the user to interact with the VCU 310. Dashboard 344 can be utilized by the vessel operator to, for example, check the state of charge on the batteries, check the connection states between powertrain components, obtain diagnostic information, configure parameters, switch an operating mode, etc. In some examples, vessel interface device 342 can be a user device 345 remote from the vessel 100, such as a smartphone, laptop, diagnostic tool, and the like. In some implementations, dashboard 344 is configured to connect to a user device 345 using a wireless protocol (e.g., Bluetooth, Wi-Fi) or through a wired link (e.g., universal serial bus (USB)). As such, dashboard 344 may act as an intermediary for communication between a user device 345 and the gateway 340.

As will be explained in more detail below, in the interest of security, dashboard 344 is not directly coupled to CAN bus 330. Instead, dashboard 344 and any other vessel interface device 342 communicates with VCU 310 and any other CAN-connected components through a secure communication tunnel implemented though local network 348 and CAN bus 330. The communication tunnel is facilitated by gateway 340. Because gateway 340 is attached to and configured for communication over CAN bus 330 as well as the local network 348, gateway 340 is operable to establish a communication tunnel for a vessel interface device 342 to access information on CAN bus 330. To that end, gateway 340 includes a tunnel server 370 configured to authenticate vessel interface devices 342 and establish a communication tunnel between the vessel interface device 342 and VCU 310 over local network 348 and CAN bus 330.

In some examples, for authentication of the vessel interface device 342, the vessel interface device 342 utilizes an authentication token. The token may be a hash-based token or an asymmetric encryption-based token, as will be explained in more detail below. In the case of dashboard 344, the token may be preconfigured in the dashboard device upon manufacture and, if needed, updated through an authorized software or firmware update of dashboard 344. In the case of a user device 345, the token may be obtained from an authorized token provider 354 after providing authentication credentials to the token provider. For example, a user may be provided with credentials for obtaining a token. After token provider 354 authenticates the user based on their credentials, token provider 354 may issue a token to the user device 345. The token can be used to authenticate the user device 345 to gateway 340 for communication with VCU 310 and other CAN-connected components.

To facilitate communication tunnelling over the local network and CAN bus, initially cryptographic credentials are preloaded in gateway 340 or in a local memory on the vessel. For example, the boat manufacturer may preload gateway 340 or local memory with cryptographic credentials before deployment. In some examples, these credentials include a shared secret key. In other examples, these credentials include a public key corresponding to a private key held by the token provider. In some implementations, the credentials are securely stored in the local memory with cryptographic protections to prevent tampering.

In some examples, to establish the communication channel between the vessel interface device 342 and gateway 340, vessel interface device 342 communicates with gateway 340 over local network 348. This channel is used for token exchange, and once the token is validated, it continues to be used for communication between the vessel interface device 342 and the gateway 340. In various examples, gateway 340 can use standard networking protocols like internet protocol (IP), transmission control protocol (TCP), user datagram protocol (UDP), Wi-Fi, and the like for communication with the vessel interface device 342. During token authentication, the vessel interface device 342 sends an authentication request with the token to gateway 340. Tunnel server 370 of gateway 340 validates the token locally, without any need for external network access. Once the token is validated, tunnel server 370 in gateway 340 manages the establishment of the communication link between the vessel interface device 342 and the VCU 310. In some examples, gateway 340 will proxy the communication, translating data from the vessel interface device 342 into CAN frames that can be delivered to VCU 310, and translating CAN frames to IP packets for delivery to the vessel interface device 342. Thus, the vessel interface device 342 cannot directly access CAN-connected components with gateway 340 serving as the intermediary.

In some examples, the tokens are generated using HMAC (Hash-based Message Authentication Code). This uses a cryptographic hash function (e.g., SHA-256) combined with a secret key. One example is JSON Web Tokens (JWTs) with HMAC-SHA256 (HS256). To verify the token, gateway 340 decodes the token using the shared secret key. For example, where the token is generated using HMAC with a shared secret key, the token provider 354 signs a payload (e.g., timestamp, device ID) with the secret key. Gateway 340 can verify the authenticity of the token by recomputing the HMAC using its stored secret key and comparing it to the token.

In other examples, the tokens are generated using authenticated encryption such as Advanced Encryption Standard-Galois Counter Mode (AES256-GCM) encryption. The token provider uses AES256-GCM with a secret key to encrypt and authenticate data, for example, the token itself can be encrypted with AES256-GCM, ensuring confidentiality. In still other examples, the tokens are generated using CMAC (Cipher-based Message Authentication Code). This is similar to HMAC, but uses a block cipher (like AES) instead of a hash function.

In some examples, tokens are generated using asymmetric cryptography. Where a public-private key pair is used, gateway 340 is preconfigured with one or more public keys of one or more trusted token providers. Token provider 354 signs the payload with its private key, allowing gateway 340 to verify it using the preloaded public key of the token provider. Gateway 340 uses the preloaded public key to verify the token’s authenticity by decrypting the token using the public key of token provider 354. If the token is valid, gateway 340 establishes a secure tunnel between the vessel interface device 342 and VCU 310. In some implementations, the tunnel is a temporary and controlled tunnel. For example, the tunnel may be automatically terminated after a predefined period or upon completion of the interaction. Tokens may have expiration times to prevent replay attacks. In some examples, gateway 340 logs authentication attempts and interactions for audit and security analysis.

In some examples, after successful token validation, tunnel server 370 gateway 340 establishes a tunnel as a proxy connection between the vessel interface device 342 and VCU 310 over the CAN bus 330. For example, gateway 340 provides CAN frame translation including the conversion between Ethernet/IP (or any other communication protocol used by the vessel interface device 342) and the CAN protocol used by CAN bus 330 and VCU 310. In one example, gateway 340 receives messages from the vessel interface device 342, encapsulates them in CAN frames, and sends them onto the CAN bus 330. When VCU 310 responds, gateway 340 translates the CAN frames sent by VCU 310 into the appropriate communication protocol (such as TCP/IP or another format used by the vessel interface device 342) for delivery to the vessel interface device 342 over local network 348.

The tunnel created through local network 348 and CAN bus 330 can be achieved through a variety of mechanisms (e.g., by converting IP packets to CAN frames, by encapsulating CAN frames in IP packets, etc.). Various tunneling protocols employed by the tunnel server 370 can include, for example, virtual private network (VPN) tunneling, secure shell (SSH) tunneling, transport layer security (TLS) tunneling, generic routing encapsulation (GRE) tunneling, and so on. With VPN tunneling, gateway 340 can function as a VPN gateway, utilizing protocols like OpenVPN, WireGuard, or IPsec. In this implementation, vessel interface device 342 creates an encrypted VPN tunnel to gateway 340, ensuring that all communication between the two remains confidential and secure. This VPN tunnel guarantees the integrity of the data as it travels across the network, protecting it from potential threats. With SSH tunneling, for secure communication, vessel interface device 342 can establish an SSH connection to gateway 340. Once the SSH connection is in place, gateway 340 acts as a conduit, forwarding the authenticated traffic to VCU 310. This creates a secure, encrypted channel through which the vessel interface device 342 and VCU 310 can communicate, safeguarding the data from unauthorized access.

With TLS tunneling, TLS encryption is used to secure the communication between vessel interface device 342 and gateway 340. Gateway 340 handles TLS termination, meaning it decrypts the traffic before forwarding it to VCU 310. This ensures that the data is encrypted during transmission to gateway 340, and the secure link continues as the traffic is sent to VCU 310. With GRE tunneling, the data packets from vessel interface device 342 are first encapsulated by gateway 340 before being forwarded through CAN bus 330 to VCU 310. This method allows gateway 340 to transport the data across the network in a secure and structured manner. For additional protection, protocols like IPsec can be added on top of the GRE tunnel, further enhancing the security of the communication as it moves between vessel interface device 342 and VCU 310.

In one example, vessel interface device 342 communicates with VCU 310 by encapsulating CAN frames in IP-based packets that are communicated to the gateway 340. For example, the vessel interface device 342 communicates over local network 348 using a protocol such as TCP/IP or UDP/IP. In this example, consider that vessel interface device 342 encapsulates a CAN frame (e.g., with the request to read data from VCU 310) in a TCP packet and forwards the TCP packet to gateway 340 over local network 348. Gateway 340 receives the TCP packet from vessel interface device 342 and extracts the CAN frame from the TCP packet. Gateway 340 forwards the CAN frame to VCU 310 over the CAN bus 330. VCU 310 processes the CAN frame and generates a response CAN frame that includes response data (e.g., sensor data). VCU 310 forwards the response CAN frame to gateway 340 over CAN bus 330. Gateway 340 receives the response CAN frame from VCU 310 and encapsulates the response CAN frame in a TCP packet. Gateway 340 forwards the response TCP packet encapsulating the response CAN frame to vessel interface device 342 over local network 348. Vessel interface device 342 extracts the response CAN frame from the response TCP packet, and processes the response data accordingly.

In another example, vessel interface device 342 communicates with VCU 310 by sending unencapsulated data in IP packets to gateway 340 over local network 348. Gateway 340 converts the IP packets received from the vessel interface device 342 into CAN frames. In this example, consider that the vessel interface device 342 sends a TCP packet with the request to read data from VCU 310. Gateway 340 receives the TCP packet from the vessel interface device 342 and extracts the requested data. Gateway 340 converts the request data into a CAN frame. Gateway 340 forwards the CAN frame to VCU 310 over CAN bus 330. VCU 310 receives the CAN frame over CAN bus 330 and processes the CAN frame. VCU 310 generates a response CAN frame that includes response data (e.g., sensor data) and forwards the response CAN frame to gateway 340 over CAN bus 330. Gateway 340 receives the response CAN frame from VCU 310 over CAN bus 330 and extracts the response data from the response CAN frame. Gateway 340 converts the response data into a TCP packet and forwards the response TCP packet to the vessel interface device 342 over local network 348. The vessel interface device 342 extracts the response data from the response TCP packet, and processes the response data accordingly.

In yet another example, vessel interface device 342 communicates with the VCU 310 by sending unencapsulated data in IP packets that are communicated to gateway 340. Gateway 340 encapsulates the IP packets in CAN frames. Consider again that vessel interface device 342 sends a TCP packet with the request to read data from VCU 310. Gateway 340 receives the TCP packet from vessel interface device 342. Gateway 340 encapsulates the TCP packet in a CAN frame. Gateway 340 forwards the CAN frame to VCU 310 over CAN bus 330. VCU 310 in this example is configured to process data in IP packets. VCU 310 extracts the TCP packet from the CAN frame and generates response data (e.g., sensor data). VCU 310 encapsulates a TCP packet including the response data in a response CAN frame. VCU 310 forwards the response CAN frame over CAN bus 330 to gateway 340. Gateway 340 receives the response CAN frame from VCU 310 and extracts the TCP packet that is encapsulated in the response CAN frame received from VCU 310. Gateway 340 forwards the response TCP packet to vessel interface device 342 over local network 348. Vessel interface device 342 extracts the response data from the response TCP packet, and processes the response data accordingly.

In this way, system 300 allows interaction between dashboard 344 and other external device with VCU 310 and other CAN-connected components while preventing direct CAN bus access, thus reducing security risks. Strong authentication mechanisms may be employed to ensure that only authorized devices can establish communication. System 300 supports flexible cryptographic methods including both symmetric (HMAC) and asymmetric (public/private key) authentication. New secret keys, token providers, and/or public keys can be imported to the vessel 100 as part of an authorized software update. Thus, system 300 provides time-limited secure tunnels, allowing controlled access while minimizing exposure to unauthorized access.

In some examples, gateway 340 includes a content server 372 configured to provide user interfaces to dashboard 344. For example, dashboard 344 may lack static control software and interfaces for sending commands to CAN-connected components, changing parameters (e.g., sport mode, eco mode, etc.), accessing state or diagnostic data, and other control functionality. Instead, these interfaces and control functionality are provided by gateway 340 through the content server 372. In one example, dashboard 344 is equipped with vessel-agnostic software components, or user software components, such as navigation software (e.g., GPS and route planning software, speed and heading, automatic identification systems), communication software (e.g., long range radio communication integration, emergency signaling integration, user device integration, etc.), entertainment software (e.g., media players), environmental monitoring software (e.g., weather and water conditions), and the like. These software components may be executed locally on dashboard 344.

However, vessel-aware software components, which provide vessel control and vessel state information, are provided through the content server. Such vessel-aware software components can include motor and system monitoring software components (e.g., motor performance monitoring, battery monitoring , range estimation, temperature and cooling system monitoring, etc.), control and automation software components (e.g., VCU control, motor control, trim and stabilization control, lighting and electrical control, pump control, etc.), maintenance and diagnostics software components (e.g., system health checks, service reminders, diagnostic trouble codes and troubleshooting, etc.). In one example, these vessel-aware software components execute on VCU 310 or gateway 340, or a combination thereof, and the user interfaces for such software components are generated by the content server 372 for rendering and display on dashboard 344. For example, content server 372 may provide application programming interfaces (APIs) for calling the software components on gateway 340. In this way, the vessel control and monitoring functionality is isolated from other user-oriented or amenity-oriented functionality of dashboard 344, thus ensuring that software components directed to vessel control and monitoring can only be modified or updated though an authorized update of gateway 340 or VCU 310. This isolation provides additional securing in that communication between dashboard 344 or other vessel interface devices 342 and CAN-connect components (e.g., VCU 310) can only occur through the secure tunnel provided by gateway 340. Thus, all communication carrying vessel control or monitoring commands, executed through interfaces provided by the content server, must be authorized and controlled by gateway 340.

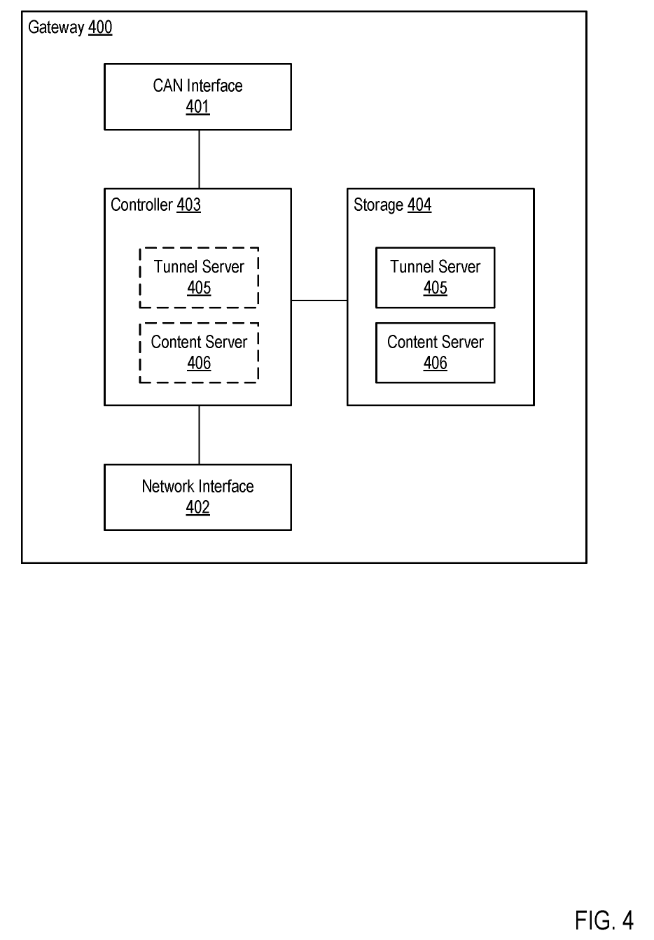

For further explanation, FIG. 4 sets forth a block diagram of an example gateway for establishing secure communication between an interface device and control systems of an electric marine vessel in accordance with at least one embodiment of the present disclosure. For example, the example gateway 400 may implement gateway 340 of FIG. 3. The example gateway 400 of FIG. 4 includes a CAN interface 401 for coupling the gateway 400 to a CAN bus (e.g., CAN bus 330 in FIG. 3). For example, the CAN interface 401 may be a CAN bus controller configured to send and receive messages in the form of CAN frames over the CAN bus. The example gateway 400 also includes a network interface 402. Network interface 402 is the collection of computer software, hardware, and firmware that allows gateway to communicate with vessel interface devices through a local network such as an IP-based network. Network interface 402 may include hardware, such as cable interfaces or Wi-Fi signal transceivers, software or hardware for packetizing and/or de-packetizing data for communication network transmission, and so forth. Network interface 402 may implement various IP-based protocols, such as TCP/IP and UDP/IP, although network interface 402 is not limited to such protocols.

The example gateway 400 also includes a controller 403 that may include or implement a processor, a microcontroller, an ASIC, PLA such as an FPGA, or other data processing unit in accordance with the present disclosure. In some examples, controller 403 is implemented by a processor or central processing unit configured to execute computer programming instructions, also referred to a computer executable instructions or processor executable instruction. Such instructions can be loaded from and stored in one or more memory devices collectively referred to as storage 404. Storage 404 may include EEPROM such as Flash memory (e.g., NAND and NOR flash memory or other types of solid-state memory), DRAM, SRAM, magnetic disk storage, and the like. The storage 404 may be integrated with the controller 403 or provided as a separate memory device coupled to the controller 403. In some examples, storage 404 is configured to store cryptographic information, such as one or more public keys of one or more authorized token providers, or a secret key or hash function operable to decrypt token information. In some examples, storage 404 includes mechanisms for cryptographically storing information, such that information stored in storage 404 can only be read by controller 403.

Controller 403 implements a tunnel server 405 such as tunnel server 370 of FIG. 3. In some examples, tunnel server 405 is embodied in programmable logic or integrated circuitry of controller 403. In other examples, tunnel server 405 is embodied in computer programing instructions stored in tangible persistent storage such as storage 404. When executed by controller 403, tunnel server 405 is configured to receive a connection request from an interface device through a first network interface, authenticate the interface device based on a token received with the connection request, establishing, in response to authenticating the interface device, a secure communication tunnel between the interface device and one or more vessel components coupled to the CAN bus, and proxy communication between the interface device and the one or more vessel components through the secure communication tunnel.

Controller 403 implements a content server 406 such as content server 372 of FIG. 3. In some examples, content server 406 is embodied in programmable logic or integrated circuitry of controller 403. In other examples, content server 406 is embodied in computer programing instructions stored in tangible persistent storage such as storage 404. When executed by controller 403, content server 406 is configured to generate a user interface and causing the user interface to be displayed on the interface device. The content server 406 may include various APIs to provide functionality to the user interface.

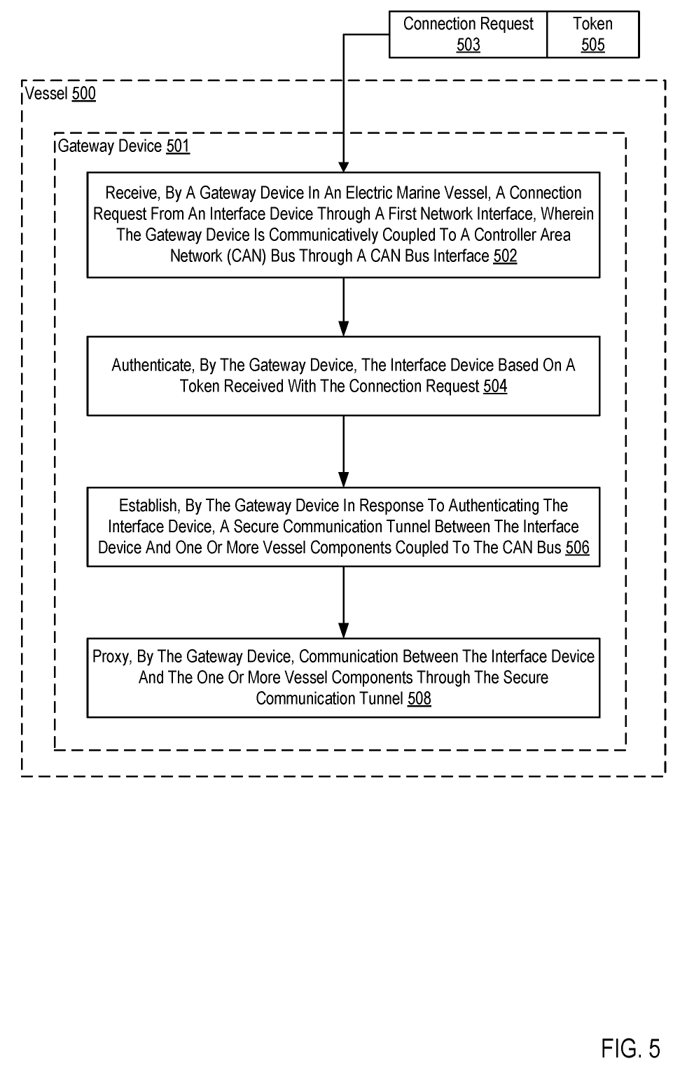

For further explanation, FIG. 5 sets forth a flow chart of an example method of establishing secure communication between an interface device and control systems of an electric marine vessel in accordance with at least one embodiment of the present disclosure. The example of FIG. 5 includes a gateway device 501 of an electric marine vessel 500. Electric marine vessel 500 may include an arrangement of components similar to electric marine vessel 100 of FIG. 1A. Gateway device 501 may implement gateway 340 of FIG. 3 and/or gateway 400 of FIG. 4. As such, gateway device 501 includes a first network interface (e.g., network interface 402 in FIG. 4) operable to connect the gateway device to a local network (e.g., local network 348 in FIG. 3). Similarly, gateway device 501 includes a CAN bus interface (e.g., CAN bus interface 401 in FIG. 4) operable to connect gateway device to a CAN bus (e.g., CAN bus 330 in FIG. 3) for communication with other CAN connected components such as a VCU, PDU, DCDC converter, marine propulsion system, etc.

The method of FIG. 5 includes receiving 502, by a gateway device 501 in an electric marine vessel 500, a connection request 503 from an interface device through a first network interface, where the gateway device is communicatively coupled to a controller area network (CAN) bus through a CAN bus interface. In some examples, gateway device 501 receives 502 the connection request 503 by receiving one or more packets over a local network communicatively coupled to the first network interface. For example, the first network interface and local network may implement IP-based protocols such as TCP/IP, UDP/IP, and the like. The first network interface may include wired interfaces (e.g., an Ethernet port) and wireless interfaces (e.g., a Wi-Fi or Bluetooth transceiver). Implicitly or explicitly, the one or more packets of the connection request 503 may embody an authentication request. For example, header information in the packets may indicate an authentication request associated with authentication information such as a token. Thus, the connection request 503 may include or be associated with an authentication token 505 that is received via the first network interface from the interface device.

The method of FIG. 5 also includes authenticating 504, by the gateway device 501, the interface device based on a token 505 received with the connection request 503. In some examples, token 505 is a hash-based token generated using a secret key shared by a token provider (e.g., an authorized token provider or vessel manufacturer). For example, token 505 may be an HMAC token in which a hash function is applied to payload using the secret key. The hash value is transmitted with the payload data. In such an example, gateway device 501 authenticates 504 the interface device by applying the hash function to the payload data using the shared secret key and validating that the resulting hash value matches the received hash value. In other examples, token 505 is an asymmetric encryption-based token in which payload data is encrypted using a private key of the token provider. The token includes an identity of the token provider, the encrypted payload data, and the plaintext payload data. In such an example, gateway device 501 authenticates 504 the interface device by decrypting the encrypted payload data using a public key corresponding to the identity of the token provider and verifying that the decrypted payload data matches the plaintext payload data. In various examples, the public keys of authorized token providers, the shared secret key, or other cryptographic information are preloaded into the vessel by an authorized vessel technician, for example, at manufacture.

The method of FIG. 5 also includes establishing 506, by the gateway device 501 in response to authenticating the interface device, a secure communication tunnel between the interface device and one or more vessel components coupled to the CAN bus. In some examples, gateway device 501 establishes 506 the secure communication tunnel by creating a tunnel session and a unique identifier for the tunnel and generating a data structure for the tunnel that includes tunnel parameters for the tunnel. For example, the tunnel parameters mapped to the unique identifier can include protocol information (e.g., TCP/IP, UDP/IP), port numbers, identifying information of the tunnel endpoints such as IP addresses, MAC addresses, and/or other device identifiers that are mapped to the tunnel, a session key for the tunnel, encapsulation types, session duration and expiration information, and so on. In some examples, establishing 506 the secure communication tunnel includes communicating tunnel session information to the interface device, such as the tunnel identifier, a port number of the gateway device for the tunnel, session key information, and the like. Once the secure communication tunnel is established, all communication received from the interface device is processed by gateway device 501 in accordance with the tunnel parameters recorded in the data structure. For example, an IP-based packet that encapsulates data for transmission through the tunnel may include the tunnel identifier in the header information of the packet. Gateway device 501 then processes the packet based on the tunnel parameters corresponding to the tunnel identifier. In a particular example, gateway device 501 establishes a secure communication tunnel between the interface device and the VCU.

The method of FIG. 5 also includes proxying 508, by the gateway device 501, communication between the interface device and the one or more vessel components through the secure communication tunnel. In some examples, gateway device 501 proxies 508 communication between the interface device and a vessel component (e.g., a CAN-connected powertrain component) by receiving one or more packets (e.g., IP-based packets) via the first network interface, converting data in the packets to one or more CAN frames, and transmitting the CAN frames over the CAN bus via the CAN interface. In some examples, gateway device 501 proxies 508 communication between the interface device and a vessel component (e.g., a CAN-connected powertrain component) by receiving a CAN frame over the CAN bus via the CAN interface, converting data in the CAN frame to one or more packets (e.g., IP-based packets), and transmitting the packets via the first network interface.

In some examples, the interface device is a dashboard of the vessel 500. The dashboard is not directly connected to the CAN bus and thus communicates with CAN-connected components via gateway device 501. In some examples, the interface device is a user device such as a laptop, smartphone, diagnostic tool, and the like. For example, the user device may connect to the dashboard for accessing the local network communicatively coupling the dashboard and the gateway device 501.

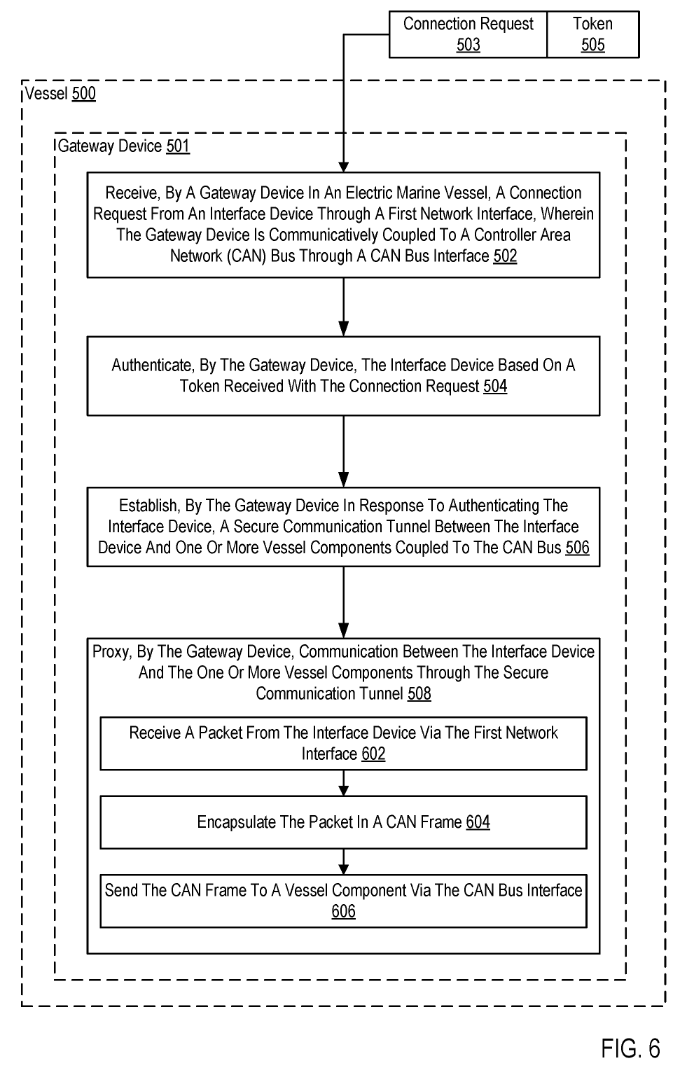

For further explanation, FIG. 6 sets forth a flowchart of another example method of establishing secure communication between an interface device and control systems of an electric marine vessel in accordance with at least one embodiment of the present disclosure. The method of FIG. 6 extends the method of FIG. 5 in that proxying 508, by the gateway device 501, communication between the interface device and the one or more vessel components through the secure communication tunnel includes receiving 602 a packet from the interface device via the first network interface. In some examples, gateway device 501 receives 602 an IP-based packet via the first network interface over an IP-based local network. For example, the packet may include a command to the VCU, a request to modify a parameter in a CAN-connected component, a request to read state information, and the like.

In FIG. 6, proxying 508, by the gateway device 501, communication between the interface device and the one or more vessel components also includes encapsulating 604 the packet in a CAN frame. In some examples, gateway device 501 encapsulates the packet in a CAN frame by adding a CAN frame header as an outer header or wrapper of the IP-based packet. In some examples, if the data payload is too larger, the data from the IP-based packet may be divided between multiple CAN frames.

In FIG. 6, proxying 508, by the gateway device 501, communication between the interface device and the one or more vessel components also includes sending 606 the CAN frame to a vessel component via the CAN bus interface. In some examples, gateway device 501 sends 606 the CAN frame by transmitting the CAN frame encapsulating the IP packet over the CAN bus to a CAN-connected component such as the VCU. In this example, the CAN-connected component (e.g., the VCU) includes packet processing logic configured to parse the IP packet after removing the CAN frame header.

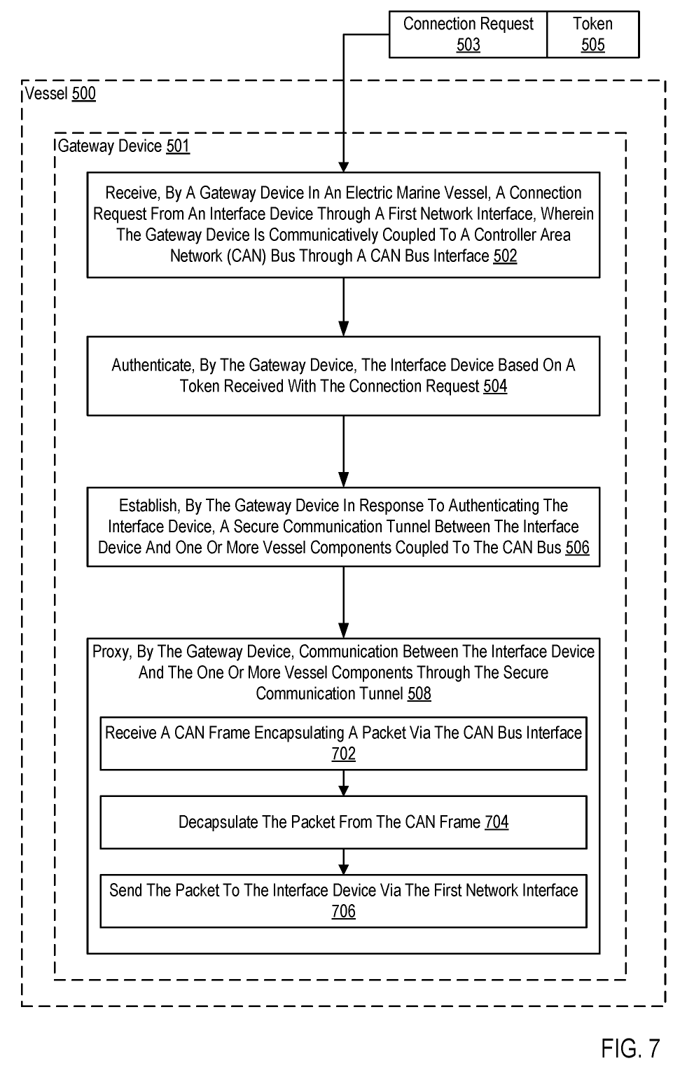

For further explanation, FIG. 7 sets forth a flowchart of another example method of establishing secure communication between an interface device and control systems of an electric marine vessel in accordance with at least one embodiment of the present disclosure. The method of FIG. 7 extends the method of FIG. 5 in that proxying 508, by the gateway device 501, communication between the interface device and the one or more vessel components through the secure communication tunnel includes receiving 702 a CAN frame encapsulating a packet via the CAN bus interface. In some examples, a CAN-connected component sends a response packet that is encapsulated in a CAN frame. For example, the VCU may be configured to generate an IP-based packet. The VCU encapsulates the IP-based packet in the CAN frame. Gateway device 501 then receives 702 the CAN frame over the CAN bus via the CAN interface.

In FIG. 7, proxying 508, by the gateway device 501, communication between the interface device and the one or more vessel components also includes decapsulating 704 the packet from the CAN frame. In some examples, gateway device 501 decapsulates 704 the packet from the CAN frame by removing the CAN frame header from the IP-based packet.

In FIG. 7, proxying 508, by the gateway device 501, communication between the interface device and the one or more vessel components also includes sending 706 the packet to the interface device via the first network interface. In some examples, gateway device 501 sends 706 the packet to the interface device by transmitting the IP-based packet over the IP-based local network coupling the first network interface of gateway device 501 and the interface device.

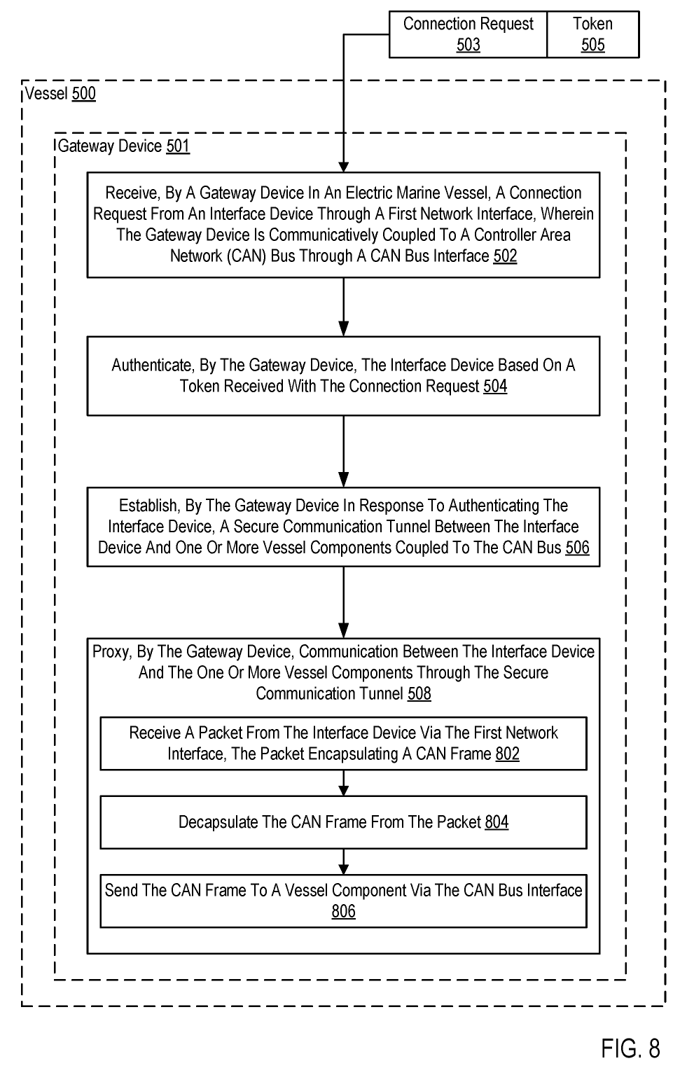

For further explanation, FIG. 8 sets forth a flowchart of another example method of establishing secure communication between an interface device and control systems of an electric marine vessel in accordance with at least one embodiment of the present disclosure. The method of FIG. 8 extends the method of FIG. 5 in that proxying 508, by the gateway device 501, communication between the interface device and the one or more vessel components through the secure communication tunnel includes receiving 802 a packet from the interface device via the first network interface, the packet encapsulating a CAN frame. In some examples, the interface device is configured to send and receive CAN frames. For example, the interface device may include a diagnostic application. In these examples, gateway device 501 receives 802 a packet that encapsulates a CAN frame by receiving a packet that includes an IP-based header that wraps the CAN frame.

In FIG. 8, proxying 508, by the gateway device 501, communication between the interface device and the one or more vessel components also includes decapsulating 804 the CAN frame from the packet. In some examples, gateway device 501 decapsulates 804 the CAN frame by removing the IP header from the packet.

In FIG. 8, proxying 508, by the gateway device 501, communication between the interface device and the one or more vessel components also includes sending 806 the CAN frame to a vessel component via the CAN bus interface. In some examples, gateway device 501 sends 806 the CAN frame by transmitting the CAN frame over the CAN bus to a vessel component such as the VCU.

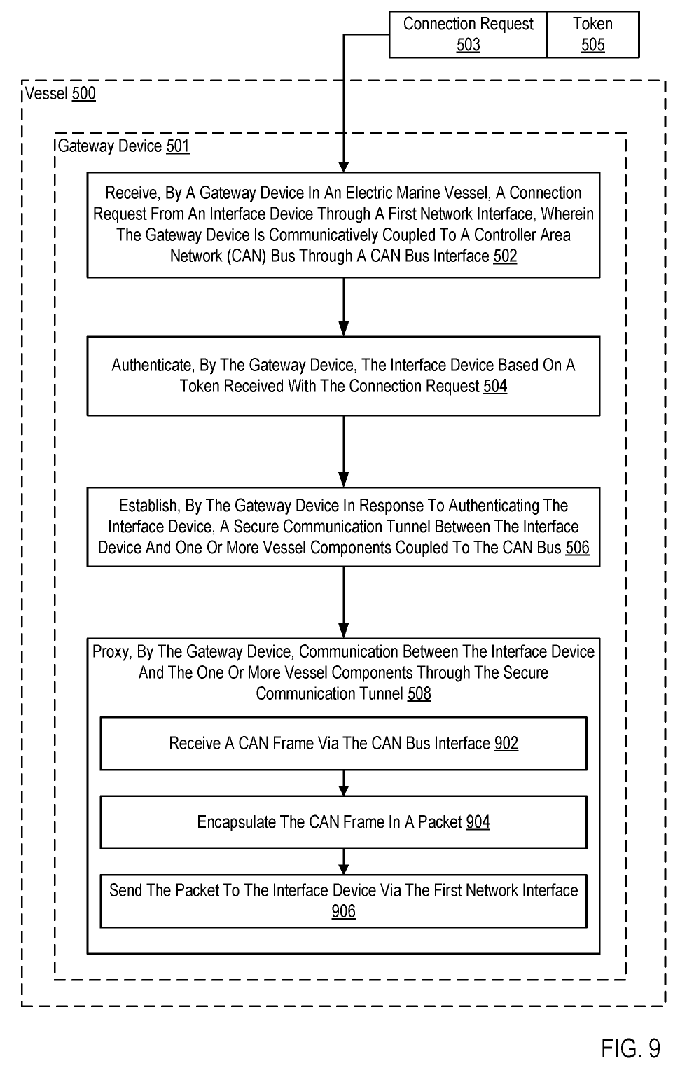

For further explanation, FIG. 9 sets forth a flowchart of another example method of establishing secure communication between an interface device and control systems of an electric marine vessel in accordance with at least one embodiment of the present disclosure. The method of FIG. 9 extends the method of FIG. 5 in that proxying 508, by the gateway device 501, communication between the interface device and the one or more vessel components through the secure communication tunnel includes receiving 902 a CAN frame via the CAN bus interface. In some examples, gateways device receives 902 a response CAN frame from a CAN-connected component (e.g., the VCU) over the CAN bus.

In FIG. 9, proxying 508, by the gateway device 501, communication between the interface device and the one or more vessel components also includes encapsulating 904 the CAN frame in a packet. In some examples, gateway device 501 encapsulates 904 the CAN frame in a packet by wrapping the CAN frame with an IP-based header.

In FIG. 9, proxying 508, by the gateway device 501, communication between the interface device and the one or more vessel components also includes sending 906 the packet to the interface device via the first network interface. In some examples, the gateway device 501 sends 906 the packet to the interface devices as discussed above.

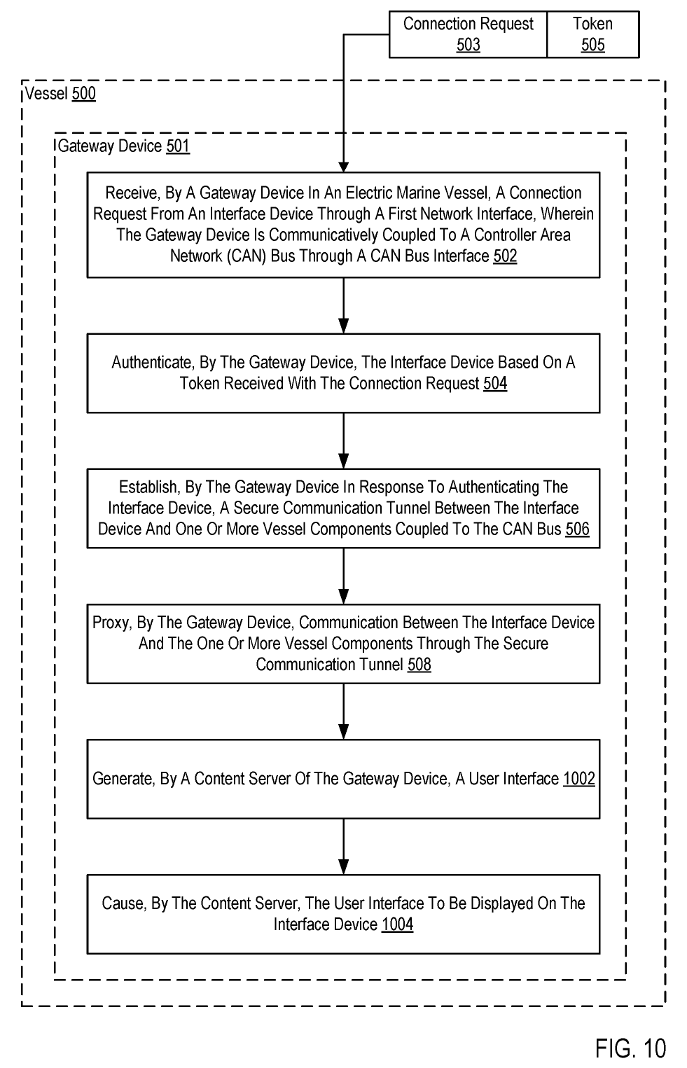

For further explanation, FIG. 10 sets forth a flowchart of another example method of establishing secure communication between an interface device and control systems of an electric marine vessel in accordance with at least one embodiment of the present disclosure. The method of FIG. 10 extends the method of FIG. 5 in that the method of FIG. 10 includes generating 1002, by a content server of the gateway device, a user interface. In some examples, the interface device is a vessel dashboard that lacks native software components for controlling the vessel and accessing vessel parameters and state information. In these examples, a content server in gateway device 501 implements APIs for such software components that execute locally on gateway device 501 or other CAN-connected components (e.g., the VCU). In such implementations, the content server generates 1002 a user interfaces by generating display content that accesses the APIs of gateway device 501 for controlling the vessel or vessel components, modifying vessel parameters, and so on. For example, generating the user interface may include rendering buttons, menus, and the like with display elements that, when actuated by the operator, call an API in gateway device 501. In response to the API call, gateway device 501 executes the appropriate software component to carry out the requested functionality. In this way, the dashboard does not execute software components that directly modify vessel functionality.

The method of FIG. 10 also includes causing 1004, by the content server, the user interface to be displayed on the interface device. In some examples, the content server causes 1004 the user interface to be displayed on the dashboard by transmitting user interface content to the dashboard over the local network via the first network connection.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a gateway device in an electric marine vessel, an authentication request from an interface device through a first network interface, wherein the gateway device is communicatively coupled to a controller area network (CAN) bus through a CAN bus interface;
authenticating, by the gateway device, the interface device based on a token received with the authentication request;
establishing, by the gateway device in response to authenticating the interface device, a secure communication tunnel between the interface device and one or more vessel components coupled to the CAN bus; and
proxying, by the gateway device, communication between the interface device and the one or more vessel components through the secure communication tunnel.

2. The method of claim 1, wherein the one or more vessel components includes a vessel control unit (VCU), and wherein the secure communication tunnel is established between the interface device and the VCU.

3. The method of claim 1, wherein the one or more vessel components includes a VCU, a power distribution unit, a battery, and an electric outboard motor.

4. The method of claim 1, wherein the first network interface utilizes an internet protocol, and wherein the CAN bus interface utilizes a CAN protocol.

5. The method of claim 4, wherein the interface device is a dashboard of the electric marine vessel, and wherein the dashboard is communicatively coupled to the first network interface of the gateway device via a first network.

6. The method of claim 4, wherein the interface device is a user device communicatively coupled to the first network interface of the gateway device via a first network.

7. The method of claim 1, wherein proxying, by the gateway device, communication between the interface device and the one or more vessel components through the secure communication tunnel includes:
receiving a packet from the interface device via the first network interface;
encapsulating the packet in a CAN frame; and
sending the CAN frame to a vessel component via the CAN bus interface.

8. The method of claim 1, wherein proxying, by the gateway device, communication between the interface device and the one or more vessel components through the secure communication tunnel includes:
receiving a CAN frame encapsulating a packet via the CAN bus interface;
decapsulating the packet from the CAN frame; and
sending the packet to the interface device via the first network interface.

9. The method of claim 1, wherein proxying, by the gateway device, communication between the interface device and the one or more vessel components through the secure communication tunnel includes:
receiving a packet from the interface device via the first network interface, the packet encapsulating a CAN frame;
decapsulating the CAN frame from the packet; and
sending the CAN frame to a vessel component via the CAN bus interface.

10. The method of claim 1, wherein proxying, by the gateway device, communication between the interface device and the one or more vessel components through the secure communication tunnel includes:
receiving a CAN frame via the CAN bus interface;
encapsulating the CAN frame in a packet; and
sending the packet to the interface device via the first network interface.

11. The method of claim 1 further comprising:
generating, by a content server of the gateway device, a user interface; and
causing, by the content server, the user interface to be displayed on the interface device.

12. An apparatus comprising:
a first network interface operable to communicate over a first network;
a controller area network (CAN) bus interface operable to communicate over a CAN bus of an electric marine vessel;
a processing device; and
memory operatively coupled to the processing device, wherein the memory stores computer program instructions that, when executed, cause the processing device to carry out operations including:
receiving an authentication request from an interface device through the first network interface;
authenticating the interface device based on a token received with the authentication request;
establishing, in response to authenticating the interface device, a secure communication tunnel between the interface device and one or more vessel components coupled to the CAN bus; and
proxying communication between the interface device and the one or more vessel components through the secure communication tunnel.

13. The apparatus of claim 12, wherein the one or more vessel components includes a vessel control unit (VCU), and wherein the secure communication tunnel is established between the interface device and the VCU.

14. The apparatus of claim 12, wherein the one or more vessel components includes a VCU, a power distribution unit, a battery, and an electric outboard motor.

15. The apparatus of claim 12, wherein the first network interface utilizes an internet protocol, and wherein the CAN bus interface utilizes a CAN protocol.

16. The apparatus of claim 15, wherein the interface device is a dashboard of the electric marine vessel, and wherein the dashboard is communicatively coupled to the first network interface via a first network.

17. The apparatus of claim 15, wherein the interface device is a user device communicatively coupled to the first network interface via a first network.

18. The apparatus of claim 12, wherein proxying communication between the interface device and the one or more vessel components through the secure communication tunnel includes:
converting data received in a packet from the interface device via the first network interface into a CAN frame; and
sending the CAN frame over the CAN bus via the CAN bus interface.

19. The apparatus of claim 12, wherein proxying communication between the interface device and the one or more vessel components through the secure communication tunnel includes:
converting data received in a CAN frame from a vessel component via CAN bus interface into a packet; and
sending the packet to the interface device via the first network interface.

20. A computer program product comprising:
a set of one or more computer readable storage media; and
computer program instructions, collectively stored in the set of one or more storage media, that when executed, cause a processor set to perform computer operations comprising:
receiving, by a gateway device in an electric marine vessel, an authentication request from an interface device through a first network interface, wherein the gateway device is communicatively coupled to a controller area network (CAN) bus through a CAN bus interface;
authenticating, by the gateway device, the interface device based on a token received with the authentication request;
establishing, by the gateway device in response to authenticating the interface device, a secure communication tunnel between the interface device and one or more vessel components coupled to the CAN bus; and
proxying, by the gateway device, communication between the interface device and the one or more vessel components through the secure communication tunnel.
